(19) United States
(12) Patent Application Publication
(10) Pub. No.: US 2015/0240791 A1
(43) Pub. Date: Aug. 27, 2015

(54) SOLAR WATER PUMP

(71) Applicants: Priyam SAXENA, (US); Madhavi L., (US)

(72) Inventors: Priyam Saxena, Hyderabad (IN); Madhavi L, Hyderabad (IN)

(21) Appl. No.: 14/421,446

(22) PCT Filed: Oct. 26, 2012
(86) PCT No.: PCT/IB2012/055913

§ 371 Date: Feb. 13, 2015

(30) Foreign Application Priority Data
Aug. 28, 2012 (IN) 3547/CHE/2012

(51) Int. Cl. F03G 6/00; F04C 15/00; F04C 2/332; F04F 5/54; F04F 5/12

(52) U.S. Cl. CPC F03G 6/001; F04F 5/54; F04F 5/12; F04C 2/332; F04C 15/008

(57) ABSTRACT

Exemplary embodiments of the present invention are directed towards a solar water pump. The solar water pump includes an organic fluid pump connected to a receiver tank of a condenser to pump and pressurise a liquefied organic fluid into the organic fluid tank placed closer to a header of an evacuated tube collector to store the pressurised liquefied organic fluid, a first pressure and temperature switch connected to the organic fluid tank to sense the pressure and temperature of the organic fluid vapour and to operate a first solenoid valve placed between the organic fluid tank and a power generator for supplying the organic fluid vapour to the power generator and a second pressure switch connected to the organic fluid tank controls the power input to the organic fluid pump through a circuit breaker; a second solenoid valve, connected between the condenser chamber and the mechanical pump, prevents the flow of motive fluid from the condenser chamber to the mechanical pump when the mechanical pump is not in operation.

### TECHNICAL FIELD OF THE INVENTION

The present invention generally relates to the field of water pumping devices. More particularly, the present invention relates to a system and method of utilizing the power generated from the solar heat to pump the water from deep wells or any water body through a jet pump.

### BACKGROUND OF THE INVENTION

Many of the conventional methods use an electric motor pump which consists axial/radial impellers and an electric motor for rotating the axial/radial impellers. The electric motor further includes an output shaft connected to the axial/radial impellers, radial bearings for supporting the output shaft. When the axial/Radial impellers are driven for providing energy to a fluid in the electric motor pump, a Torque is applied to the output shaft of the electric motor. This torque increases with an increase in a discharge amount and/or a discharge pressure of the fluid. Electric motor generating required torque is major cost component required to drive the pump.

Conventionally, the power required to drive pump is not only generated by the electric motors it can also be generated through the solar energy by using concentrated solar rays. Solar panels made up of a plurality of photovoltaic (PV) cells are often used for the direct conversion of sunlight to the electrical energy. Such panels may be mounted on rooftops or other exterior structures exposed to the sun to generate electric power. In addition to the power received from the panels, a system may be connected to the local power grid to draw power from the grid at night or during overcast days and even to provide power to the grid when the amount of power created exceeds the energy usage of the system. The amount of sunlight that a solar panel absorbs and the amount of electrical energy it generates, varies greatly with its orientation relative to the sun. But this method uses DC Permanent Magnet motors which are very costly or AC motors with DC to AC converter which is equally costly and the other method of pumping is using solar thermal power to generate electric power which is used to drive the electric motor. This has cost implications of electric motor as well as generator.

In the light of aforementioned discussion there exists a need for solar water pump which uses solar thermal power to generate a power required to pump water from the deep wells or any water body.

### BRIEF SUMMARY OF THE INVENTION

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

A more complete appreciation of the present invention and the scope thereof can be obtained from the accompanying drawings which are briefly summarized below and the following detailed description of the presently preferred embodiments.

Exemplary embodiments of the present invention are directed towards a solar water pump. According to an exemplary aspect, the solar water pump includes an organic fluid pump connected to a receiver tank of a condenser and configured to pump and pressurize a liquefied organic fluid into the receiver tank placed closer to a header of an evacuated tube collector. A photovoltaic array is connected to the organic fluid pump for driving the organic fluid from the receiver tank of the condenser to the header of the evacuated tube collector. Further a circuit breaker is connected between the photovoltaic array and an organic fluid pump to control the power input to the organic fluid pump.

In accordance with an exemplary aspect, the solar water pump includes an organic fluid tank positioned closer to the header of the evacuated tube collector for storing the pressurised liquefied organic fluid from the organic pump and the pressurised organic fluid vapour received from the header of the evacuated tube collector. The evacuated tube collector collects heat from the solar rays, Other way of providing energy by heat exchanger introduction into organic fluid tank, using heat generated by burning a liquid petroleum gas, heat generated by burning compressed natural gas, heat generated by burning a fossil fuel and the like for converting the liquefied organic fluid into an organic fluid vapour. A plurality of annulus spaces between a plurality of evacuated inner tubes and the tubes which may include but not limited to a plurality of copper tubes, a plurality of aluminum tubes and a plurality of tubes made of a thermally conductive material and the like are filled with the high temperature fluid to enhance a heat transferred to the liquid organic fluid inside the copper tube. The hallow structure header may include but not limited to a square cross section, a rectangular cross section and a circular cross section and the like divided by a baffle. Bottom part of baffle separated header is connected to bottom half of evacuated tube diameter in the evacuated tube collector as well as bottom of organic fluid tank. Top side of the baffle separated header is connected to top half of evacuated tube diameter in the evacuated tube collector as well as to the organic fluid tank. High pressure and high temperature organic fluid vapour generated by solar heat/radiation as well as running the organic fluid pump through the photovoltaic cells.

According to the exemplary aspect, the solar water pump includes a first pressure switch and a temperature switch connected to the organic fluid tank for sensing a pressure and a temperature of the organic fluid vapour and to operate a solenoid valve placed between the organic fluid tank and a power generator for controlling the supply of the organic fluid vapour to the power generator.

In accordance with an exemplary aspect, the solar water pump includes a second pressure switch connected to the organic fluid tank to control the power input to the organic fluid pump.

In accordance with an exemplary aspect, the power generator includes a crank case assembly comprising top cover, bottom cover and a sliding vane backed by a spring, crank shaft with roller which is eccentric in nature with crank shaft. The high pressure organic fluid vapour is transmitted to the crank case assembly to generate the required shaft power. The crank case assembly forms a variable volume depending on the angle of the crank shaft. The manually or automatically operable starter valve is mounted over the crank case for transmitting the high pressure organic fluid vapour into the crank case during the restart of the power generator.

In accordance with an exemplary aspect, the power generator includes an eccentricity of crank shaft, positioned inside the crank case bore, that will be in contact with the sliding vane on one side and the other side with the crank case wall or dry lubricant bearing and will rotate due to a predetermined expansion of the organic fluid in the crank case, thus the required shaft power is generated.

In accordance with an exemplary aspect, the solar water pump includes a power generator. The power generator includes a rotating valve consists a circumferential slot positioned above a top cover and attached to crank shaft. Top cover consists an inlet port and sits above the crank case. Matching of the port on top cover with the circumferential slot of a rotating valve decides the duration and the amount of high pressure organic fluid vapour to be entered into crank case. The opening angle for the circumferential slot on the rotating valve ranges from 5 degrees to 190 degrees. The position of the circumferential slot on the rotating valve with reference to the port on the top cover decides a required percentage of total variable volume need to be filled to optimise the performance.

In accordance with an exemplary aspect, the power generator includes a bottom cover positioned at the bottom of the crank case configured to accommodate a crank case assembly to form a variable volume depending upon the crank shaft angle with respect to the sliding vane. The expansion of high pressure and high temperature organic fluid vapour inside the crank case rotates the crank shaft for producing the required shaft power.

In accordance with an exemplary aspect, the power generator includes a low pressure tube connected with the crank case positioned at the maximum variable volume position to release an expanded gas.

In accordance with an exemplary aspect, the power generator includes a shaft connected with the power generator to transmit the power delivered by the crank shaft to a mechanical pump for pumping the water as a motive fluid to the jet pump. The mechanical pump combined with the power generator and jet pump to deliver the water from the deep wells and the heat exchanger placed at the outlet of the water coming out from the jet pump is used for condensing the low pressure organic fluid vapor. Further to this, the water goes out as an output from the system. Additionally, some of the water after heat exchanger will be used as motive fluid for the mechanical pump. This closes the circuit of the complete system.

In accordance with an exemplary aspect, the power generator includes a shell comprising an inlet tube to allow the flow of high pressure and the temperature organic fluid vapour into the crank case assembly through the rotating valve from the shell. The crank case assembly encapsulated in a shell configured to support by closing the bottom with a plate comprising an oil seal and a means to extend the crank shaft below the plate and a hole to provide egress to a tube coming out from the crank case for facilitating to take out expanded vapour. The oil seal is positioned in the bottom cover plate to avoid the leakage of the high pressure organic fluid from the power generator. Oil inside the bottom of shell will be used for lubricating the parts in crank case assembly as well as seals the vapour. The plurality of dry lubricant surfaces may include but not limited to a bronze filled, a graphite filled poly tetra fluoro ethylene with an elastomer back up mounted over the inner wall of the crank case or on the roller and the like to accommodate the dimensional variations of inner surface of crank case, eccentricity of crank shaft and a plurality of parts in contact with crank shaft to provide a proper sealing.

In accordance with an exemplary aspect, the power generator includes a high pressure tube connected to the power generator for transmitting the high pressure organic fluid vapour to the power generator. The top of the organic fluid tank is connected by a tube to the power generator to ensure only an entry of the organic fluid vapour.

### BRIEF DESCRIPTION OF THE DRAWINGS

The above-mentioned and other features and advantages of this present disclosure, and the manner of attaining them, will become more apparent and the present disclosure will be better understood by reference to the following description of embodiments of the present disclosure taken in conjunction with the accompanying drawings, wherein:

FIG. 1 is a diagram depicting an overview of a solar water pump.

FIG. 2 is a diagram depicting an exploded view of a power generator.

FIG. 3 is a diagram depicting a combination of the rotating valve with circumferential slot and the top cover with a port included in a power generator.

FIG. 4a is diagram depicting a combination of a crank case and a crank shaft included in a power generator positioned at a start of expansion stroke.

FIG. 4b is a diagram depicting a combination of a crank case and a crank shaft included in a power generator positioned at discharge stroke.

FIG. 5 is a diagram depicting exploded view of a mechanical pump.

### DETAIL DESCRIPTION OF THE INVENTION

It is to be understood that the present disclosure is not limited in its application to the details of construction and the arrangement of components set forth in the following description or illustrated in the drawings. The present disclosure is capable of other embodiments and of being practised or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and the like, herein do not denote any order, quantity, or importance, but rather are used to distinguish one element from another.

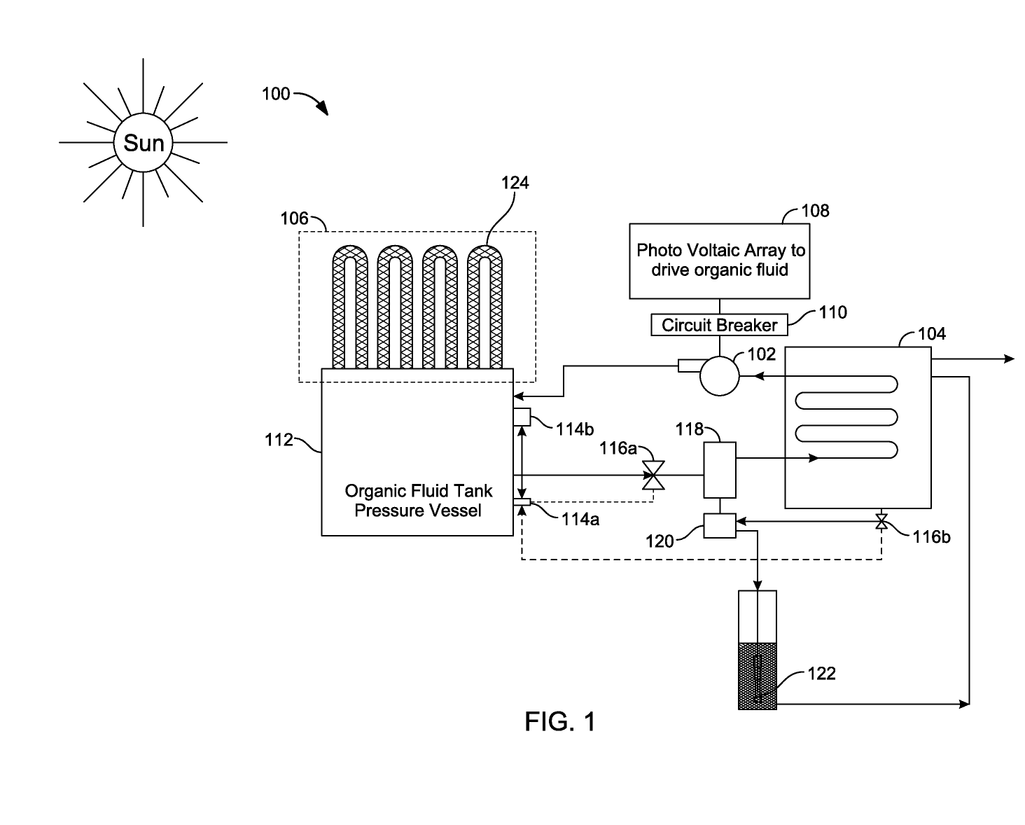

Referring to FIG. 1 is a diagram 100 depicting an overview of a solar water pump. According to a non limiting exemplary embodiment of the present invention, the solar water pump includes an organic fluid pump 102 driven by a photo voltaic array 108 to pump and pressurise the liquefied organic fluid from a condenser 104 into organic fluid tank 112, which in turn is connected to the header 124 of an evacuated tube collector 106. The system further includes a circuit breaker 110, a first pressure and temperature switch 114a, a second pressure and temperature switch 114b, a first solenoid valve 116a, a second solenoid valve 116b, a power generator 118, a mechanical pump 120 and a jet pump 122.

In accordance with a non limiting exemplary embodiments of the present invention, the organic fluid pump 102 is connected to the receiver tank of a condenser 104 to pump and pressurise the liquefied organic fluid from the condenser 104 into the organic fluid tank 112 placed near to the header 124 of an evacuated tube collector 106. The header 124 may include but not limited to a square cross section, a rectangular cross section and a circular cross section and the like which is divided by a baffle into two parts. The bottom portion of the baffle separated header 124 is connected to the bottom of organic fluid tank 112 on one side and to the evacuated tube collector 106 on the other side. The top portion of the baffle separated header 124 is connected again to the organic fluid tank 112 for collecting the organic fluid vapour at high temperature and pressure. The organic fluid pump 102 is driven by a photo voltaic array 108 to drive the liquefied organic fluid from the receiver tank of the condenser 104. A circuit breaker 110 connected between the photo voltaic array 108 and the organic fluid pump 102 is used to control the power input to organic fluid pump 102. The transmitted liquefied organic fluid enters into the organic fluid tank 112 and then into the header 124 of the copper tubes enclosed within an evacuated inner tubes of the evacuated tube collector 106. The multiple annulus spaces between evacuated inner tubes and the tubes of material may include but not limited to copper, aluminium, any thermally good conductive material and the like are filled with the high temperature fluid to enhance the heat transferred to the liquefied organic fluid inside the copper tubes. Thus this arrangement of filling high temperature fluid in the annulus spaces eliminates the need of high pressure grade glass tubes for evacuated tube collector 106 and saves the cost. Further, the solar heat absorbed by the evacuated tube collector 106 is transferred to the liquid organic fluid present inside the copper tubes for converting the liquid organic fluid into vapour at high temperature. The source of heat for converting the liquid organic fluid into vapour may include but not limited to solar rays, heat generated by burning a liquid petroleum gas, heat generated by burning compressed natural gas, heat generated by burning a fossil fuel and the like and further stored in the organic fluid tank 112.

According to a non limiting exemplary embodiment of the present invention, the stored organic fluid vapour is transmitted to the power generator 118 through the first solenoid valve 116a. The first pressure and temperature switch 114a connected to the organic fluid tank 112 senses the pressure and temperature of the stored organic fluid vapour in the organic fluid tank 112 and then decides whether to open or close the first solenoid valve 116a. The first solenoid valve 116a connected between the organic fluid tank 112 and the power generator 118 gets activated to allow the high pressure organic fluid vapour into the power generator 118. The first pressure and temperature switch 114a is set to a predetermined value for opening and closing of first solenoid valve 116a to optimize the power generated in a power generator 118. Similarly the second pressure and temperature switch 114b connected to the organic fluid tank 112 is used to signal the circuit breaker 110 that controls the power input to the organic fluid pump 102, to ensure that the organic fluid pump 102 is not operated when the temperature of organic fluid vapour in the organic fluid tank 112 is not sufficiently high.

In accordance with a non limiting exemplary embodiment of the present invention, the pressure and temperature sensed by the first pressure and temperature switch 114a activates the first solenoid valve 116a to transfer the high pressure organic fluid vapour to the power generator 118. The high pressure organic fluid vapour transmitted to the power generator 118 is used to generate the shaft power. Thus the generated shaft power is transmitted to a mechanical pump 120 that pressurises and supplies motive fluid (water) to a jet pump 122 for pumping the water from the well. Further the low pressure expanded organic fluid vapour from crank case 216 will leave the power generator 118 at the end of expansion and enters into the condenser 104. The low pressure expanded organic fluid vapour from the power generator 118 is condensed to a low pressure organic fluid liquid by the exchange of heat with the water coming out from the jet pump 122. The second solenoid valve 116b connected between the mechanical pump 120 and the condenser chamber is used to control the motive water depending upon the shaft power generated from the power generator 118.

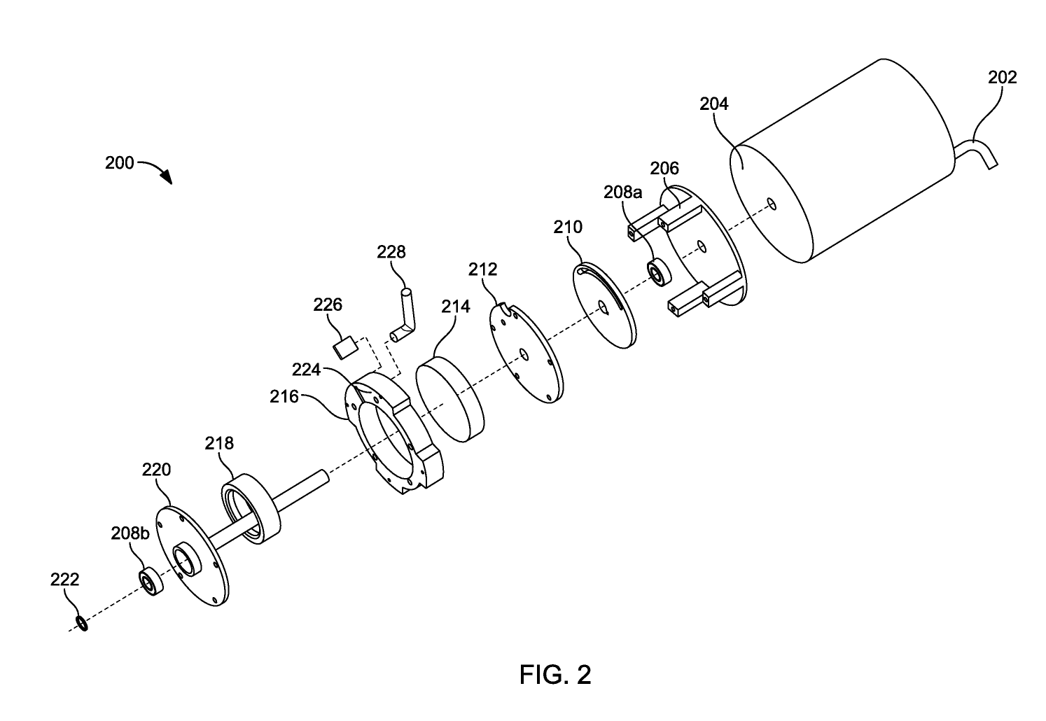

Referring to FIG. 2 is a diagram 200 depicting an exploded view of a power generator. According to a non limiting exemplary embodiment of the present invention, the power generator includes a power generator shell 204, a high pressure tube 202, a cage 206, a first bearing 208a, a second bearing 208b, a rotating valve 210, top cover 212, a dry lubricant bearing 214, a crank case 216, a crank shaft 218, a bottom cover 220, an oil seal 222, a starter valve 224, a sliding vane 226 and a low pressure tube 228.

In accordance with a non limiting exemplary embodiment of the present invention, a high pressure tube 202 connected to one end of the power generator shell 204 is used to transmit the high pressure organic fluid vapour from the organic fluid tank to the power generator shell 204. The cage 206 enclosed in the power generator shell 204 holds critical parts that generate required shaft power. The rotating valve 210 with circumferential slot comes above the top cover 212, connected to the crank shaft 218 and rotates along with the crank shaft 218. The high temperature and high pressure organic fluid vapour will enter into the crank case 216, as long as the circumferential slot on the rotating valve 210 and the port on the top cover 212 are matched. This concept of matching the circumferential slot on the rotating valve 210 with the port on the top cover 212 for allowing the organic fluid vapour into crank case 216 optimises the performance of the power generator by allowing the organic fluid vapour into crank case 216 only during the expansion stroke. The circumferential slot on the rotating valve 210 will not be over the port on the top cover 212 of the crank case 216, thus the high pressure and high temperature organic fluid vapour cannot enter into the crank case 216 during the discharge stroke. The expansion of high pressure and high temperature organic fluid vapour inside of the crank case 216 rotates the crank shaft 218, thus generating the required shaft power. The discharge stroke starts at the end of the expansion stroke. The low pressure expanded organic fluid vapour is released during the discharge stroke, from the crank case 216 to leave the power generator shell 204 through a low pressure tube 228.

According to a non limiting exemplary embodiment of the present invention, the dry lubricant bearing with an elastomer back up 214 may include but not limited to a bronze filled, a graphite filled poly tetra fluoro ethylene with an elastomer back up and the like are mounted over the inner walls of the crank case 216 to accommodate the dimensional variations between inner surface of crank case 216 and eccentricity of crank shaft 218. To avoid the fluid leakage during the expansion of high pressure organic fluid vapour a strict adherence to the dimensional tolerance between crank case 216 and the eccentricity of crank shaft 218 is needed and it involves a costly machining processes. The dry lubricant bearing with an elastomer back up 214 helps in providing the required sealing between crank case 216 and the eccentricity of crank shaft 218 in a cost effective way. The power generator further includes a bottom cover 220 positioned at the bottom of the crank case 216 is used to accommodate a crank case assembly to form a variable volume depending upon the crank shaft angle with respect to the sliding vane 226. The expansion of the high pressure and the high temperature organic fluid vapour inside the crank case 216 rotates the crank shaft 218 for producing the required shaft power. The bottom cover 220 positioned at the bottom of the crank case 216 is used to accommodate the crank shaft 218 and a crank case assembly including a crank shaft 218, a crank shaft eccentricity, a sliding vane 226, a crank case 216, a top cover 212 and a bottom cover 220 to form a variable volume depending upon the angle of the crank shaft 218 with respect to the sliding vane 226. The expansion of the high pressure and the high temperature organic fluid vapour inside the crank case 216 rotates the crank shaft 218 thus producing the required amount of shaft power. An oil seal 222 positioned below the second bearing 208b is used to provide lubrication to the multiple moving parts and to provide a sealing against the leakage of the high pressure organic fluid vapour from the power generator shell 204.

In accordance with a non limiting exemplary embodiments of the present invention, the starter valve 224 mounted over the crank case 216 is used to operate manually or automatically for transmitting the high pressure organic fluid vapour into the crank case 216. There is a possibility for a mismatch between the circumferential slot on the rotating valve 210 and the port on the top cover 212 during the restart of the cycle and this will not allow the high temperature and high pressure organic fluid vapour to enter into the crank case. Thus the starter valve 224 when operated manually or automatically, allows the high pressure organic fluid vapour to directly enter into the crank case 216 and starts the rotation of crank shaft 218. Once the crank shaft 218 starts rotating, the rotating valve 210 also rotates, gets aligned with the port on the top cover 212 and allows the high pressure organic fluid vapour to enter into crank case 216, thus starting the delivery of shaft power. Once the high pressure vapour starts entering into the crank case 216 through the rotating valve 212, the starter valve 224 will be closed. Further the power generator includes a sliding vane 226 that is placed in the crank case 216 to separate expanding gas from the expanded gas, by being in contact with the crank shaft eccentricity continuously. The sliding vane 226 supported by a spring traverse in and out of the slot provided in the crank case 216 to maintain the contact with the crank shaft eccentricity. The low pressure tube 228 is used to transmit the low pressure expanded gas released from the crank case 216 to the condenser 104 where it gets converted into a low pressure liquid by exchanging heat with the water coming out from the jet pump.

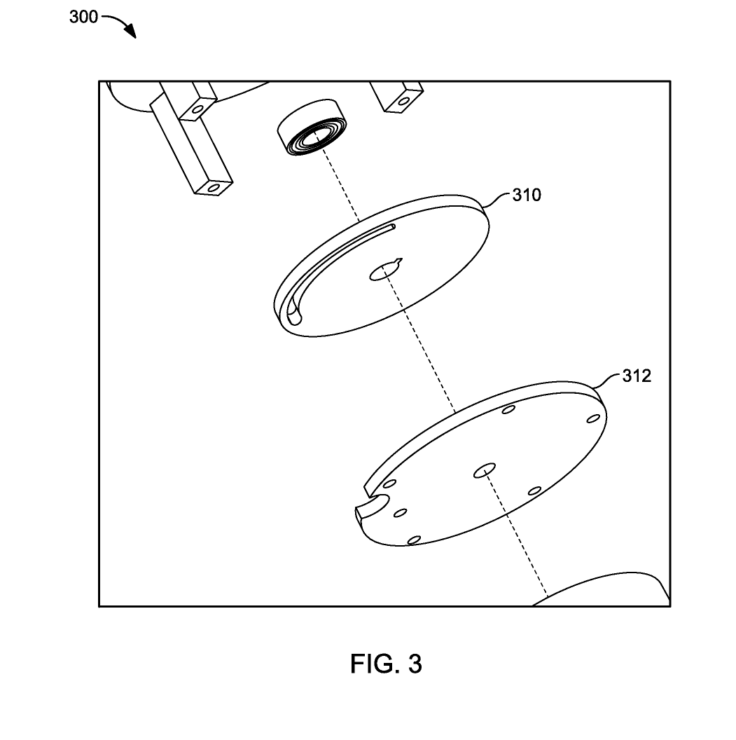

Referring to FIG. 3 is a diagram 300 depicting an enlarged exploded view of the assembly of rotating valve 310 with circumferential slot and the top cover 312 with the port. As long as the port on the top cover 312 is uncovered by the circumferential slot on the rotating valve 310, the high pressure and high temperature organic fluid vapour will enter into the crank case 216 and gets expanded while pushing the crank shaft 218 to rotate. The opening angle for the circumferential slot on the rotating valve 310 will range from 5 degrees to 190 degrees, so as to ensure that the high temperature and high pressure organic fluid vapour does not enter into the crank case 216 during the discharge stroke. This opening angle decides a required percentage of total variable volume of crank case 216 that needs to be filled to optimise the performance.

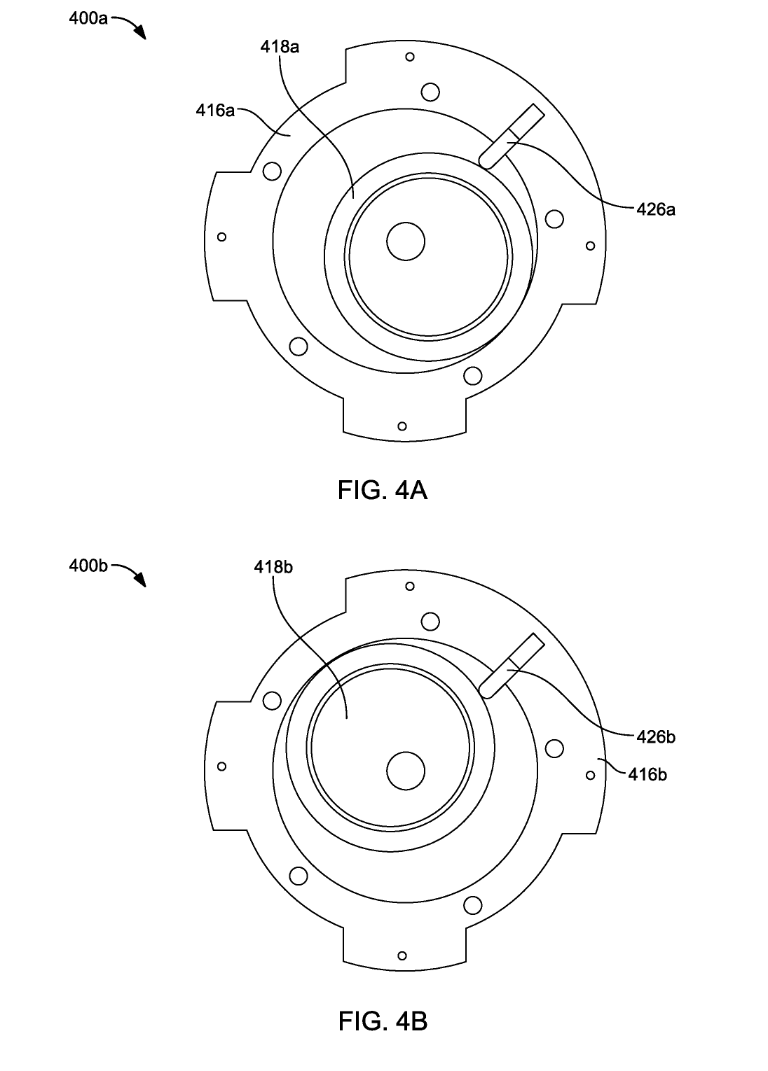

Referring to FIG. 4a is diagram 400a depicting a combination of a crank case and a crank shaft included in a power generator positioned at a start of expansion stroke. According to a non limiting exemplary embodiment of the present invention, the diagram 400a depicts a crank case 416a, crank shaft 418a and a sliding vane 426a.

Referring to FIG. 4b is a diagram 400b depicting a combination of a crank case and a crank shaft included in a power generator positioned at an end of discharge stroke. According to a non limiting exemplary embodiment of the present invention, the diagram 400b depicts a crank case 416b, a crank shaft 418b and a sliding vane 426b.

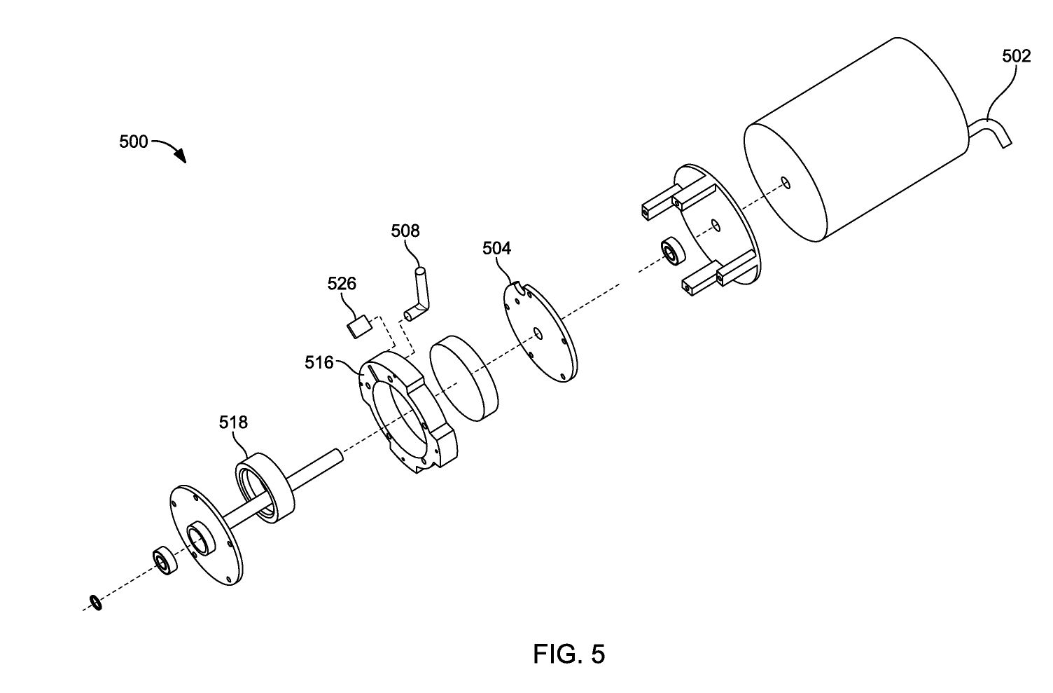

Referring to FIG. 5 is a diagram 500 depicting exploded view of a mechanical pump. According to a non limiting exemplary embodiment of the present invention, the diagram 500 depicts a discharge tube 502, a discharge valve 504, a crank case 516, an inlet tube 508 and a crank shaft 518.

In accordance with a non limiting exemplary embodiments of the present invention, the inlet tube 508 connected to the crank case 516 is used to transmit the motive fluid into the crank case 516. As the crank shaft 518 rotates, the motive fluid gets pressurised. The pressurised motive fluid will be discharged through the discharge tube 502 into motive fluid line as the discharge valve 504 in top cover of the crank case 516 will be opened by the pressurised motive fluid. The jet pump 122, which is connected to the motive fluid line, receives the pressurised motive fluid and pushes up the water from the well. The water thus discharged by the jet pump 122, will be received into condenser 104. The heat exchange between the water discharged from the jet pump 122 and the low pressure organic fluid vapour in the condenser 104 converts the vapour into liquid. The second solenoid valve 116b, connected between the condenser chamber 104 and the mechanical pump 120, prevents the flow of motive fluid from the condenser chamber 104 to the mechanical pump 120 when the mechanical pump 120 is not in operation. This arrangement helps in avoiding unnecessary drain out of water through the mechanical pump 120, back into the well.

While specific embodiments of the invention have been shown and described in detail to illustrate the inventive principles, it will be understood that the invention may be embodied otherwise without departing from such principles.

What is claimed is:

1. A solar water pump, comprising:
an organic fluid pump connected to a receiver tank of a condenser configured to pump and pressurise a liquefied organic fluid into the organic fluid tank placed near to a header of an evacuated tube collector;
an organic fluid tank positioned near to header of the evacuated tube collector is configured to store the pressurized organic fluid from the pump as well as vapour from the header of evacuated tube collector which is heated by heat generated through at least one of: solar rays; heat generated by burning a liquid petroleum gas; heat generated by burning compressed natural gas; heat generated by burning a fossil fuel; and an agricultural waste;
a first pressure switch and temperature switch connected to the organic fluid tank for sensing the pressure and temperature of organic fluid vapour and makes the decision for operating the first solenoid valve which is placed between the organic fluid tank and a power generator for the supply of organic fluid vapour to the power generator;
a second pressure switch connected to the organic fluid tank configured to control the power input to the organic fluid pump;
a power generator comprising:
a crank case assembly comprising:
a crank case comprising an inlet port and an outlet port and a sliding vane backed by a spring;
a crank shaft with eccentricity which fits inside of crankcase bore, touching one side with the sliding vane and the other side with the crankcase wall or dry lubricant bearing;
a top cover which sits on the top of the crank case with a means to accommodate the crankshaft and a port to allow the high temperature and high pressure organic fluid vapour into the crankcase;
a bottom cover which sits in the bottom of the crank case with a means to accommodate the crankshaft, the crank shaft eccentricity, the sliding vane, the crankcase, the top cover and the bottom cover which forms variable volume depending upon the crank shaft angle with respect to the sliding vane; and
a rotating valve with a circumferential slot positioned above a plurality of bearings and a cage is configured to match the circumferential slot on rotating valve with the port on top cover for transmitting a high pressure organic fluid vapour, whereby the expansion of the high pressure and the high temperature organic fluid vapour inside of the crank case makes the crank shaft to rotate producing the required shaft power and matching the circumferential slot on the rotating valve with the port on the top cover for allowing the organic fluid vapour into the crank case optimises the performance.
a low pressure tube connected with the crank case which is positioned at the maximum variable volume position configured to release an expanded gas from the power generator;
a shaft connected with the power generator configured to transmit the power delivered by the crank shaft to a mechanical pump or any other water pumping mechanism for pumping the water as motive fluid to a jet pump;
a shell encapsulating a rank case assembly which consists a plurality of supports for the crank case assembly, closed on the bottom by the bottom plate having an oil seal and a means to extend the crank shaft below the plate, whereby the shell comprises an inlet tube where high pressure and temperature organic fluid vapour can enter into the shell and subsequently into the crank case assembly and a hole to provide egress to the tube coming out from crank case which facilitates to take out expanded vapour;
a first solenoid valve positioned between the power generator and the organic fluid tank configured to transmit the high pressure organic fluid vapour to the power generator based on the predetermined pressure and temperature of the organic fluid vapour sensed by the first pressure and temperature switch; and
a second solenoid valve connected to the mechanical pump for controlling the motive fluid depending on the shaft power of power generator, whereby expanded vapour will be cooled by the water coming out of the jet pump by means of shell and tube or a plate or a coil heat exchanger and condensed organic fluid liquid will be pumped to organic fluid tank by the organic fluid pump.

2. The solar water pump of claim 1, wherein a photovoltaic array connected to the organic fluid pump for driving the organic fluid from the receiver tank of condenser to the header of the evacuated tube collector.

3. The solar water pump of claim 1, wherein a plurality of annulus between evacuated inner tubes and the copper tubes or aluminum or any other thermally conductive material are filled with the high temperature fluid to enhance heat transfer to liquid organic fluid inside of the copper tube eliminates the need for high pressure grade glass tubes for evacuated tube collector.

4. The solar water pump of claim 1 further comprises a circuit breaker connected between the photovoltaic array and an organic fluid pump to control the power input to the organic fluid pump.

5. The solar water pump of claim 1 further comprises an oil seal in the bottom plate encapsulating the shaft.

6. The solar water pump of claim 1, wherein the high pressure gas pushes oil and the oil seal stops oil leakage.

7. The solar water pump of claim 1 further comprises a plurality of dry lubricant surfaces comprising at least one of: a branze filled; a graphite filled poly tetra floro ethylene with an elastomer back up mounted over the inner wall of the crank case and on the surfaces of all moving parts where the metal to metal contact happens to accommodate the dimensional variations of inner surface of crank case, the eccentricity of crank shaft and a plurality of parts in contact with the crank shaft to provide a proper sealing.

8. The solar water pump of claim 1 further comprises a manually or automatically operable starter valve mounted over the crank case for transmitting the high pressure organic fluid vapour into the crank case whenever the power generator is restarted.

9. The solar water pump of claim 1 further comprises a baffle separated header which is a hallow structure having cross section of a square or a rectangular or a circular, wherein a bottom portion of the baffle separated header connected to the bottom of the organic fluid tank on one side and the other side to the evacuated tube collector connected in the bottom side of baffle; and the top portion of the baffle separated header is connected to the organic fluid tank which receives the high temperature and high pressure organic fluid vapour; and the top of the organic fluid tank connected by the tube to the power generator to ensure only vapour enters in to power generator.

10. The solar water pump of claim 1, wherein a rotating valve comprising a circumferential slot connected to a crankshaft and matching with the port on top cover allows the high pressure vapour into the crankcase assembly optimising the performance of power generator and the angle of opening is from 5 deg to 190 deg.

11. The solar water pump of claim 1, wherein a heat exchanger placed at the outlet of the water coming out from the jet pump for cooling the low pressure organic fluid.

12. The solar water pump of claim 1, wherein a combination of solar thermal power using direct sun heat produces the high pressure organic fluid vapour by running the organic fluid pump through the photovoltaic cells.

13. The solar water pump of claim 1, wherein the mechanical pump combines with the power generator.

14. The solar water pump of claim 1, wherein electrical power generator/Alternator combines with the power generator.

15. The solar water pump of claim 1, wherein the first pressure switch and temperature switch controls the operation of the first solenoid valve

16. A solar water pump, comprising:
a power generator comprising:
a crank case assembly comprising:
a crank case comprising an inlet port and an outlet port and a sliding vane backed by a spring;
a crank shaft with eccentricity which fits inside of crankcase bore, touching one side with the sliding vane and the other side with the crankcase wall or dry lubricant bearing;
a top cover which sits on the top of the crank case with a means to accommodate the crankshaft and a port to allow the high temperature and high pressure organic fluid vapour into the crankcase;
a bottom cover which sits in the bottom of the crank case with a means to accommodate the crankshaft, the crank shaft eccentricity, the sliding vane, the crankcase, the top cover and the bottom cover which forms variable volume depending upon the crank shaft angle with respect to the sliding vane; and
a rotating valve with a circumferential slot positioned above a plurality of bearings and a cage is configured to match the circumferential slot on rotating valve with the port on top cover for transmitting a high pressure organic fluid vapour, whereby the expansion of the high pressure and the high temperature organic fluid vapour inside of the crank case makes the crank shaft to rotate producing the required shaft power and matching the circumferential slot on the rotating valve with the port on the top cover for allowing the organic fluid vapour into the crank case optimises the performance.
